(19) United States
(12) Patent Application Publication
(10) Pub. No.: US 2022/0101715 A1
(43) Pub. Date: Mar. 31, 2022

(54) ROOM-LEVEL-SOUND-EVENT SENSOR-INITIATED REAL-TIME LOCATION SYSTEM (RTLS)

(71) Applicant: CenTrak, Inc., Newtown, PA (US)

(72) Inventors: John A. Swart, Grand Rapids, MI (US); Mark J. Rheault, Fargo, ND (US)

(21) Appl. No.: 17/548,128

(22) Filed: Dec. 10, 2021

Related U.S. Application Data
(63) Continuation-in-part of application No. 17/063,569, filed on Oct. 5, 2020, now abandoned.
(60) Provisional application No. 62/993,743, filed on Mar. 24, 2020.

(51) Int. Cl. G08B 21/22; G10L 25/78; G10L 25/72; H04L 67/12

(52) U.S. Cl. CPC G08B 21/22; H04L 67/12; G10L 25/72; G10L 25/78

(57) ABSTRACT

A room-level sound-event sensor is used to initiate the location process whenever it is likely that a person has entered or left the room. A room-level sound-event sensor is defined as an electronic sensing device that can determine whether a sound event occurs in one room, independently of what is happening in any adjacent room. In one embodiment of the invention, a room-level sound-event sensor may be a microphone. The sensed room-level sound event is the transition from a room being silent to a room being occupied by people speaking.

### FIELD OF THE INVENTION

The present invention relates generally to a real-time location system (RTLS) having active tags, bridges, and one or more room-level sound-event sensors, that pass sufficient sensor data to a location engine in a central server, to locate tags at room-level within a. building like an outpatient-healthcare clinic.

### BACKGROUND OF THE INVENTION

RTLS systems estimate locations for moving tags or moving personnel badges within a floor plan of interior rooms, in buildings such as hospitals and clinics. Many RTLS systems based on radio-frequency signals such as Wi-Fi or Bluetooth Low Energy (BLE), are designed to have moving tags that transmit a radio signal, within a field of receiving devices called bridges, gateways, sensors, or Access Points. The tag transmission initiates a process whereby a network of bridges measure and use received signal strength of transmissions from the tag, as a proxy for estimating the distance between the tag and each bridge, and then use multi-lateration or proximity algorithms to estimate the locations of tags. Those approaches with tags whose transmissions initiate the location algorithms are standard in the industry, and provide location estimates that are acceptable for many use cases in industrial and manufacturing environments. They may even be accurate enough to locate tagged assets and tagged people with accuracy within 1-meter or less. But the tag-transmission-initiated approaches common in the industry fail to provide an efficient location system for determining the entry of patients and staff into specific clinical rooms in outpatient clinics.

Outpatient clinics are typically comprised of a series of small rooms where patients receive individual care from one or more caregivers. The goal of the RTLS system will be to determine precisely which patient is in which room with which caregiver(s), and provide that information to the caregivers, and clinic managers, for optimal patient care and patient experience.

RTLS systems that are in common use in healthcare, fail to determine reliably which room the tag resides in. For example, where two exam rooms share a common wall, the RTLS systems in common use struggle to determine which side of the wall a tag resides on. Primarily, this lack of accuracy is the result of the tag's radio-transmission passing a radio signal through the wall. The tag initiates the location process by sending a radio signal. A sensor in an adjacent room may hear the tag signal more strongly than a sensor in the proper room, and the system will mis-report the tag in the incorrect, adjacent room. A better location system is required that can reliably determine which side of a wall a tag resides on, so the hospital can determine which room a patient is in, and which caregivers are in the room with the patient.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating components in a room-level-sound-event sensor-initiated RTLS, including one or more tags, one or more bridges, room-level sound-event sensors, and a location engine.

FIG. 2 is a block diagram illustrating components used in the tag;

FIG. 3 is a block diagram illustrating components used in the bridge;

FIG. 4 is a block diagram illustrating components used in the room-level sound-event sensor; and

FIG. 5 is a flow chart diagram illustrating the steps using the tags, bridges, room-level sound-event sensors and location engine to estimate tag location.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to an RTLS having active tags, room-level sound-event sensors, and bridges that pass location updates to a location engine in a central server. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of RTLS having tags, bridges, and bay-level event sensors. The non-processor circuits may include, but are not limited to, a radio receiver, a radio transmitter, signal drivers, clock circuits, power source circuits, and user input devices. As such, these functions may be interpreted as steps of a method to perform tag functions, bridge functions, and bay-level event sensor functions. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The current invention proposes a room-level-sound-event-sensor-initiated RTLS. Room-level sound-event sensors determine which rooms have likely had a tag-wearing patient or staff member enter or leave a room by detecting the sound pattern of a person entering a room, or the sound pattern of a person leaving a room. But the room-level sound-event sensor by itself may not have any capability to determine which tag has entered or left the room. Nor does the radio tag, communicating to bridges, provide the location engine with enough information to determine, by itself, which tag has entered or left any room. But the combination of the room-level sound-event sensors initiating a location process, which then considers the radio-signal-strength information from the tags and bridges, can determine which tag has entered or left a room. The room-level sound-event sensors may include microphones, or speech-recognition sensors.

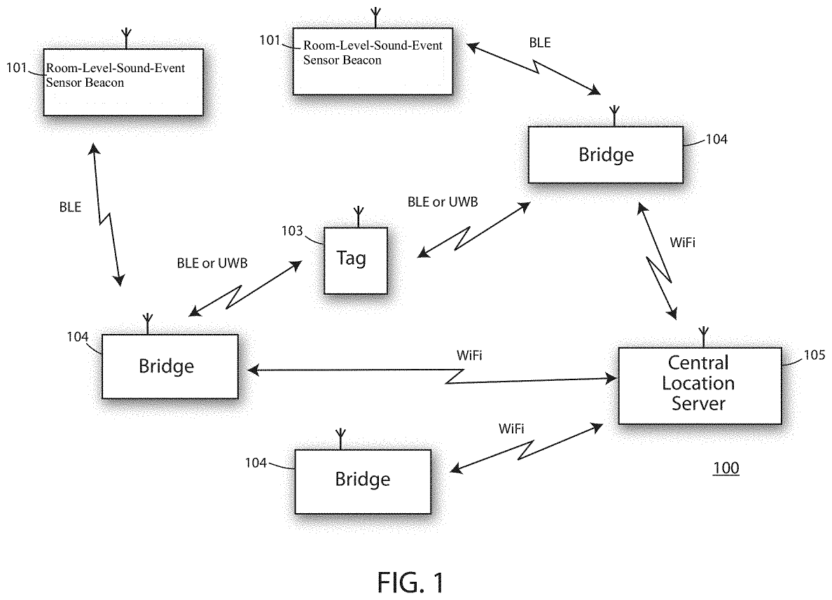

FIG. 1 is a block diagram illustrating components used in the RTLS in accordance with various embodiments of the invention. The system 100 includes one or more fixed room-level sound-event sensors 101 that sense sound events within a room, which report their sensed sound event by radio or wired transmission, including transmission to a bridge 104. Any radio transmissions from room-level sound-event sensors 101 that are received at the bridge 104 will be forwarded to a location engine 105. One or more mobile tags 103 transmit wireless messages to one or more bridges 104, using a radio protocol such as Bluetooth Low Energy (BLE), or an ultrawideband pulse. This tag transmission will contain a report of the motion status and/or events of a tag as measured by an accelerometer on the tag. As examples, the motion status of a tag may be “the tag is not moving”, or “the tag is moving slowly” or “the tag is moving at human walking speed”. The received signal strength and content of this tag transmission as well as radio-reception characteristics such as signal strength, or ultrawideband timing and phase, are retransmitted by the bridges, perhaps via Wi-Fi, or Bluetooth Low Energy (BLE), to the location engine 105.

Those skilled in the art will recognize that a location engine is an algorithm coded in software that processes sensor inputs including sensed events about transmitting tags as they move within a building, and produces an estimate of the location of those tags within a building. A sensor which detects a sound event occurring in a specific room but not an adjacent room is defined as a “room-level sound-event sensor.” The event that each room-level sound-event sensor detects, occurring in a specific room but not an adjacent room, is generally defined as a “room-level sound event”. A room-level microphone may detect an increase in ambient noise or speech in a specific room as people move into the room. A room-level-sound-event-sensor-initiated RTLS is defined as a system of tags, sensors, and a real-time location engine, which employs room-level sound-event sensors and their perceived room-level sound events to initiate a location-determination process for a set of tags. Estimating the location of a tag with a precision of determining which room a tag resides in is often named “room-level accuracy”.

As is already typical in the industry, the location engine may employ trilateration algorithms on the signal strength reports or ultrawideband-phase reports it receives from multiple bridges to form one estimate of the location of the tag. With the current invention, when a room-level sound-event sensor determines that it is likely that a tag (on a person) has entered or left a room, the location engine looks at the set of tags estimated to be near that room, and reports whether one or more of those tags has likely entered or left the room, using a set of signal strength readings, tag-accelerometer readings, and room-level sound-event-sensor readings. The output of the location engine is a location estimate, which is an estimate of the room-level-location of the tag.

Thus, the system in FIG.1 includes a novel feature not taught in the prior art namely; a system of tags, bridges, room-level sound-event-sensors and a location engine, which first uses room-level sound-event sensors to determine that a sound event (e.g. a room entry or room exit) has occurred, then uses the location engine to determine which tag or tags have entered or left the room.

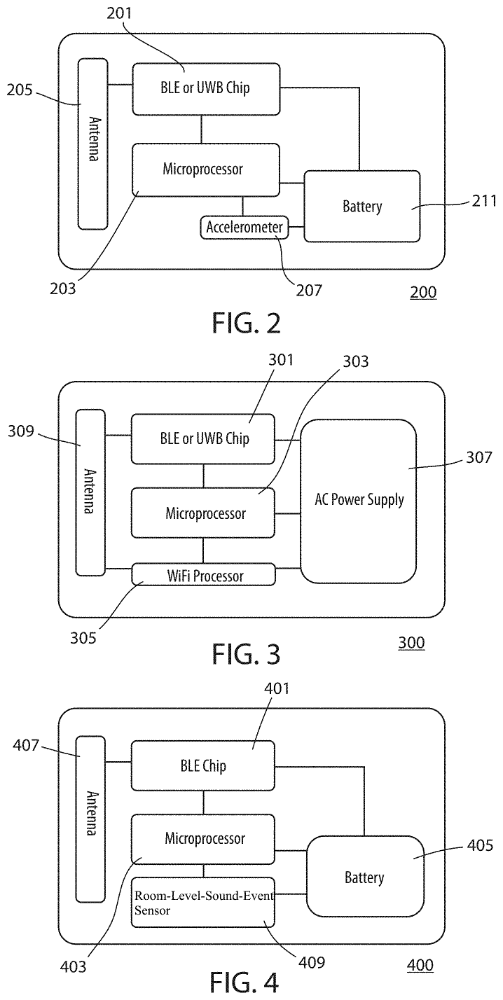

FIG. 2 is a block diagram illustrating system components used in the tag. The tag 200 includes a transceiver 201 which transmits and receives radio frequency (RF) signals. The transceiver 201 complies with the specifications of one of the set of standards Bluetooth Low Energy (BLE), Wi-Fi, Ultrawideband (UWB) or IEEE 802.15.4. The transceiver 201 is connected to a microprocessor 203 for controlling the operation of the transceiver. The transceiver is also connected to an antenna 205 for providing communication to other devices. The tag further includes an accelerometer 207 connected to the microprocessor 203 for detecting motion of the tag and a battery 211 for powering electronic components in the device. The skilled in the art will recognize that a microprocessor is an integrated circuit or the like that contains all the functions of a central processing unit of a computer.

FIG. 3 is a block diagram illustrating components used in the bridge as seen in FIG. 1. The bridge 300 includes one or more narrowband or ultrawideband transceivers 301 that connect to a microprocessor 303 for controlling operation of the transceiver(s) 301. A Wi-Fi processor 305 also connects to the processor 303 for transmitting and receiving Wi-Fi signals. An AC power supply 307 is connected to the transceiver 301, microprocessor 303 and the Wi-Fi processor 305 for powering these devices. The AC power supply 307 powers the bridge components. An antenna 309 is connected to both the BLE transceiver 301 and the Wi-Fi processor 305 for transmitting and receiving tag and Wi-Fi RF signals to these devices at the appropriate frequency. Those skilled in the art will recognize that the bridge 300 may be an access point from a Wi-Fi vendor, as long as the access point deployed at the location, such as a hospital, has functionality of the bridge 300. This permits the invention to leverage bridge functions from that existing system by adding the other portions of the system as defined herein.

FIG. 4 is a block diagram illustrating components used in a room-level sound-event sensor that senses sound events. Various embodiments of this room-level sound-event sensor that senses motion events are microphones, noise sensors, speech sensors, and voice-recognition sensors. Any of these sensors, alone or in combination, may detect a likelihood of human movement into or out of a room. The room-level sound-event sensor 400 includes a transceiver 401 for transmitting wired or radio transmissions to report the sensed data. The transceiver 401 connects to a microprocessor 403 for controlling the transceiver(s). A battery or alternate power supply 405 connects to the transceiver(s) 401 and the microprocessor 403 for powering these devices. The room-level sound-event sensor 400 that uses radio includes one or more antennas 407 for providing gain. The room-level sound-event sensor 400 includes a sensor 409, which detects sound events in the room where the room-level sound-event sensor is located, which may be one of a microphone, noise sensor, or voice-recognition sensor. The sensor 409 that detects sound events is connected to both the microprocessor 403 and battery 405, for detecting sound from anything in the room. The room-level sound-event sensor 400 typically is placed in the ceiling or high on the wall of a clinical room, so that it can sense sound events anywhere within the room. Thus, the room-level sound-event sensor 409 can determine if there are objects moving about, into, or out of the room, to help a location engine, to correlate sound events in rooms, to motion status of tags, and match moving tags to rooms that are sensed to have coincident sound. The room-level sound events can then be transmitted and/or stored in a database for determining room-level location of one or more tags.

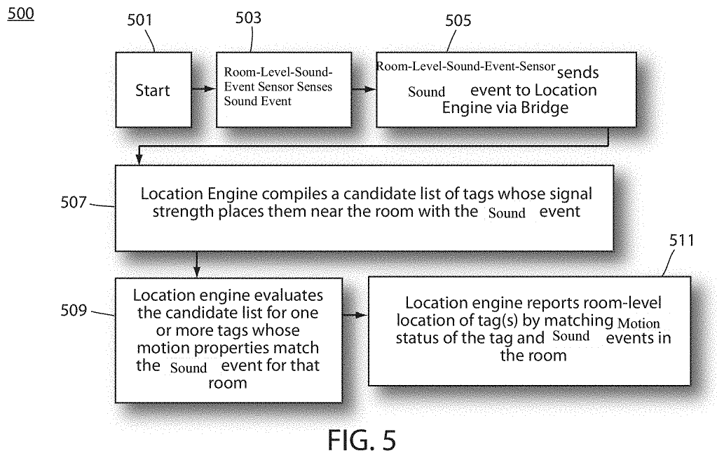

FIG. 5 is a block diagram illustrating the steps used in the location process. The methods 500 as shown in FIG. 5 include starting the process 501 where a room-level sound-event sensor senses a sound event 503. The room-level sound-event sensor transmits a radio signal 505 to notify the location engine of a sound event. The location engine 507 will compile a list of the tags whose signal strength (based on radio signal strength indication (RSSI) data from tags to bridges) places them near the room with the sound event. These tags may be worn by patients or caregivers whose room-entry or room-exit may have caused the sound event. The location engine will then evaluate the candidate list of tags for one or more tags whose motion properties (measured by their accelerometers) may match the sound event for that room 509. Next, the location engine will report the room-level location of tag(s) whose motion status matches the sound events in the room 511. For example, if the location engine knows from a report of the sound event that Room 1 has had one or more people enter, it will search the reports of radio signal strength for which tags are near room 1 to obtain a candidate list of (for example) tags A, B and C. The location engine may find that tag A was not moving when the room-entry occurred so it is eliminated from consideration, and tag C was continuously moving at walking speed until well after the sound stopped in room 1 so is eliminated from consideration. But tag B showed motion at walking speed when Room 1 had a room-entry sound event, so tag B is the tag most likely to have entered Room 1. The location engine may also observe from the radio-signal-strength of tag B's transmissions to bridges that tag B has increasing signal strength in room 1, plus that tag B's accelerometer shows a reduction from walking speed to no-more-walking just after the room-entry event, and these data confirm the likelihood that tag B has entered room 1.

Those skilled in the art will recognize that an attribute of the current invention is the use of room-level sound-event sensors to initiate the location process, to improve the location estimate to room-level. Radio frequency signals can suffer fades, absorption and reflection, all of which decrease its signal strength. As a result, the location engine that relies solely on radio frequency signal strength(s) to determine location will make location-estimate errors and erroneously place an asset or person in the wrong room. For some RTLS applications and use cases, determining which room an asset is in, is of the utmost importance. Therefore, an RTLS system that uses room-level sound-event sensors to improve the estimate with greater accuracy is a novel improvement.

Typically, in a RTLS, radio signals sent by a tag or tags to the multiple bridges will suffer from a variety of polarity fades, i.e., mismatches between the polarity of the transmitting antenna on the tag and the receive antenna on the bridge. These polarity fades work to dispel the general assumption that the RSSI of the advertisement from the tag to the bridge is directly correlated to the distance between the tag and the bridge. Therefore, this adds error to the location estimate, mis-estimating which room a tag is placed. In addition, some of the tags will be blocked (by metal objects or other assets) from a clear line of sight to the one or more bridges, further breaking the correlation of signal strength to distance. Some of the tags will have their radio energy absorbed by human bodies or bottles of water, further breaking the relationship of signal strength to distance. The tag may stop in a location where it happens to suffer from a persistent multipath fade relative to a specific bridge, so that bridge will mis-estimate its distance to the tag. Finally, all of these radio fading effects are time-varying, as people and metal objects move through the hospital's rooms, so using radio signal strength alone to estimate the location of an asset tag will make a stationary asset appear to move from time to time.

All of these radio-fading effects make it very difficult to estimate which room each of the patients-with-tags and caregivers-with-tags have arrived in, producing erred room-location estimates. Room 1 may be less than 1 meter from the adjacent Room 2. If the RTLS location algorithm has 1-meter accuracy 90% of the time, then the algorithm will fail to estimate the correct room-level location of all assets and people 10% of the time. Hence, those skilled in the art will reach the conclusion that radio signal strength alone is insufficient for determining which room a patient or caregiver resides in, even if it is 1-meter accurate or half-meter accurate. Signal-strength measurements are degraded by too many radio fading effects.

Hence, the present invention uses room-level sound-event sensors to help determine in which room a tag is located. Room-level sound-event sensors have a relative advantage in that they perceive the sound changes inside a room, but they are unaware of any sound in any adjacent room because those movements are in a different room shielded from the sensor by a sound-blocking wall. In using the system and methods of present invention, the room-level sound-event sensor in room 1 senses objects moving, or producing sound in room 1. The room-level sound-event sensor in room 2 senses objects moving or producing sound in room 2. Neither room-level sound-event sensor can sense sufficient sound on the opposite side of the wall in the adjacent room.

With the present invention, each room-level sound-event sensor in each room sends a periodic transmission of sound events. In one embodiment of the present invention, a room-level sound-event sensor such as a microphone senses a transition from room-silence to room-with-sound, and that room-level sound-event is transmitted to the location engine. In another embodiment of the present invention, the room-level event sensor may be a a voice detector, or a speech recognition sensor. Since sound-event changes in one room are likely to be non-coincident with sound-event changes in an adjacent room, each room will have a unique “sound-event fingerprint” for its last few minutes of observed time. A “sound-event fingerprint” is a record of a room's sound events over a recent few second's time. The location engine can store these “sound-event fingerprints” for each room, for use in the location estimate. As an example, a combination of a sound of a door opening, then a transition from silence to speech, then the sound of human walking into a room, followed by the sound of a door closing, is a strong indicator of the likelihood that a patient or caregiver or both have entered a room. When a location engine compiles a candidate list of tags that may have entered the room, the location engine consults additional information to get a room-level location fix: It will compare the patterns of the motion statuses of the candidate tags as reported in the tag's transmissions, to the “sound-event fingerprints” of the room. The location engine will match tag(s) to a room location based on a match between the tags' reported motion statuses and the room's sound-event fingerprint.

As an illustration of the unique benefit of the current invention, consider the challenge of locating a tag-wearing staff member, or patient. Radio signals are absorbed by the human body. The location engine that uses only radio signal-strength will struggle to determine where a staff member or patient is actually located, and may report an adjacent (incorrect) room as the location of the staff tag. In one embodiment of the current invention, the room-level sound-event sensor may report (in each transmission) the current sound-event status in the room as measured at the room-level sound-event sensor, plus the sound-event status at predetermined time periods (e.g. six seconds ago and 12 seconds ago).

As an example, a room-level sound-event sensor in room 2 can report in one or more transmissions that there was no sound-event in a room 12 seconds ago, a walking-sound-event (consistent with a human at walking speed) six seconds ago, and sound now that is consistent with a person who has stopped walking. Two staff tags or patient tags that are perceived equally likely to be near room 2 based on signal strength, report the motion status of their accelerometers. Patient tag P may report a motion pattern similar to a patient sitting in a room for the last 12 seconds. Patient tag Q reports that it has been walking for the last 12 seconds but just now that walking has slowed, as if the tag wearer just stopped walking and entered a room. The location engine can determine that the tag P is unlikely to be in the room with the room-level sound-event sensor. However, tag Q is very likely to be in the room with the room-level sound-event sensor. The location engine is therefore more accurate than a system based on signal strength alone.

Hence, the RTLS in the current invention uses at least three algorithmic methods and/or processes to estimate the room-level location of a tag. These processes include:
1) Matching of sound events reported by room-level sound-event sensors and motion status reported by tags, to estimate the room-level location of a tag.
2) Use of radio-signal strength and trilateration to estimate a location of a tag, which may not be a room-level-accurate estimate.
3) Finally, the RTLS blends its location estimates from the two processes above to finalize its room-level location estimate for the tag.

In one embodiment of the invention, the radio-signal-strength estimate is determined in the location engine, using reports of received signal strength at the bridges. In an alternate embodiment of the invention, the radio-signal-strength estimate is determined in the tag, which listens for the radio transmissions from multiple room-level sound-event sensors, and estimates its own location, based on the relative signal strengths of the sound-event sensors in several rooms.

Thus, the current invention proposes a novel use of a room-level sound-event sensor to initiate the location process whenever it is likely that a person has entered or left the room. A room-level sound-event sensor is defined as an electronic sensing device that can determine whether a sound event occurs in one room, independently of what is happening in any adjacent room. In one embodiment of the invention, a room-level event sensor may be a microphone. The sensed room-level sound-event is the transition from a room being silent to a room being occupied by people speaking. It is very likely that a patient or caregiver starts speaking or creating ambient noise when a patient or caregiver enters a room, and very unlikely that there is ambient noise or human speech in a room after all occupants have left. The room-level ambient noise or human-speech sensor can determine whether a person is likely occupying or leaving its monitored room, without being misled by people occupying or leaving any adjacent room.

A unique aspect of the invention, is that the room-level sound-sensors are specified to initiate the locating process whenever it is likely that a patient or caregiver has changed rooms, executing the location process to determine which patient or staff member has entered that room. This is in marked contrast to historical RTLS systems which initiated the process at the tag, then executed the location process to attempt to determine which room the tag resides in, often choosing a mistaken or adjacent room.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A real-time location system (RTLS) having tags, room-level sound-event sensors, bridges, and a location server for providing people and asset-tag locating, comprising:
a central server;
at least one tag which transmits a report of its motion status as sensed by its accelerometer;
at least one room-level sound-event sensor, which transmits a report of sound events that occur in a room to a location engine;
at least one bridge for receiving reports from at least one tag and measuring at least one characteristic of the received transmissions, the characteristic including received signal strength characteristic or an Ultrawideband (UWB) characteristic, and forwarding those reports to the central server, that receives transmissions of reports from the at least one room-level sound-event sensor, which report sound events that occur in a room; and
a location engine which initiates a process to estimate the room-level location of the at least one tag, whenever it receives a sound-event report from a room-level sound-event sensor.

2. The RTLS as in claim 1, wherein the at least one tag further comprising:
a transceiver;
a microprocessor for driving the transceiver;
a battery for powering the transceiver;
and an accelerometer for detecting motion, used by the microprocessor to determine and report changes in the motion-status of the at least one tag.

3. The RTLS as in claim 2, wherein the transceiver complies with the specifications of at least one of the set of standards defining Bluetooth Low Energy (BLE), Wi-Fi, Ultrawideband (UWB) or IEEE 802.15.4

4. An RTLS as in claim 1, the at least one room-level sound-event sensor comprising:
a transceiver;
a microprocessor for operating the transceiver;
a sensor for detecting sound events in the room-level sound-event-sensor's room; and
a power supply for powering the transceiver and the microprocessor.

5. The RTLS as in claim 4, wherein the room-level sound-event sensor is at least one of a microphone, a voice-recognition sensor, or a speech-recognition sensor.

6. The RTLS as in claim 4, wherein the room-level sound-event sensor transmits its detection of sound events through one of a wireless network or a wired network to the location engine.

7. A real-time location system (RTLS) having tags, room-level sound-event sensors, bridges, and a location server for providing people and asset-tag locating, comprising:
at least one room-level sound-event sensor, which wirelessly transmits a report of its sensation of sound events that occur in a room;
at least one tag for listening for radio transmissions from the at least one room-level sound-event sensor and measuring multiple characteristics of those received transmissions, including received signal strength and the report of sound events in the room-level sound-event sensor's room, where accelerometer-sensed-motion status of the tag is compared to sound events received in the room-level sound-event sensors' transmissions, and location-estimate messages are transmitted to the at least one bridge;
at least one bridge for receiving reports from at least one tag and forwarding those location-update messages to a central server, which also receives reports from the at least one room-level sound-event sensor, and forwards those reports to a central server; and
a location engine which initiates a process to estimate the room-level location of the at least one tag, whenever it receives a sound-event report from a room-level sound-event sensor.

8. An RTLS as in claim 7, the at least one tag further comprising:
a transceiver;
a microprocessor for driving the transceiver;
a battery for powering the transceiver; and
an accelerometer for detecting motion, used by the microprocessor to determine and report changes in the motion-status of the tag.

9. The RTLS as in claim 8, wherein the transceiver complies with the specifications of at least one of the set of standards defining Bluetooth Low Energy (BLE), Wi-Fi, Ultrawideband (UWB) or IEEE 802.15.4

10. An RTLS as in claim 7, the at least one room-level sound-event sensor comprising:
a transceiver;
a microprocessor for operating the transceiver;
a sensor for detecting sound events in the room-level sound-event sensor's room; and
a power supply for powering the transceiver and the microprocessor.

11. The RTLS as in claim 10, wherein the room-level sound-event sensor is one of the set of a microphone, a voice-recognition sensor, or a speech-recognition sensor.

12. The RTLS as in claim 11, wherein the room-level sound-event sensor transmits its detection of sound events through one of a wireless network or a wired network to the location engine.

13. A method of estimating room-location for at least one asset tag used in a real-time location system (RTLS), comprising the steps of:
receiving an event notification generated by a room-level sound-event sensor, indicating a sound event in its room;
initiating a location-estimation process for that room; and
estimating which tag or tags may have entered or left the room based on reports of radio-signal characteristics for one or more tags, received from bridges near that room.
